(19) United States
(12) Patent Application Publication
(10) Pub. No.: US 2003/0163350 A1
(43) Pub. Date: Aug. 28, 2003

(54) Automated system facilitating interactions between physicians and medical services or equipment providers

(76) Inventors: Robert Rudowski, Mattawan, MI (US); Ronald Colcernian, Waterford, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/143,256

(22) Filed: May 9, 2002

Related U.S. Application Data
(60) Provisional application No. 60/360,218, filed on Feb. 26, 2002.

(51) Int. Cl. G06F 17/60

(52) U.S. Cl. 705/2

(57) ABSTRACT

A system facilitates automated, remote communication between a variety of individuals or entities involved in the process of providing medical services or equipment to patients. A communication module facilitates automated remote communication using a network accommodating hard wire, wireless, internet, intranet or Ethernet technologies, for example, to share information between physicians, therapists, nurses, facilities, manufacturers, insurance providers, equipment providers, payors and caregivers to expedite the therapeutic process. The inventive arrangement eliminates redundancies and promotes efficiencies that are realized through automatic generation of required documentation in expediting communications between all entities involved in the process of providing the necessary care. In one example, the inventive arrangement facilitates automatically generating a certificate of medical necessity at the time that a physician places an order for a selected prescribed therapy. In one example, the certificate of medical necessity includes an electronic signature that is acceptable to replace a hand signature on a hardcopy of the certificate as has been previously required. An inventive testing device arrangement for facilitating data retrieval from the device is also disclosed.

### CROSS REFERENCE TO RELATED APPLICATIONS

This application claims priority to U.S. Provisional Application No. 60/360,218, filed on Feb. 26, 2002.

### BACKGROUND OF THE INVENTION

This invention generally relates to an automated system for providing home medical equipment. More particularly, this invention relates to an automated system that facilitates all steps of the process involved in communications between the various individuals or entities involved in providing medical equipment or related services.

The current approach to providing home medical equipment to individual patients is time-consuming, labor-intensive, expensive and inefficient. A typical scenario begins when a patient consults their physician regarding some medical condition. The physician determines whether an assessment or testing is needed to determine whether a particular ongoing treatment plan will benefit the patient. For example, the physician may determine that the patient would possibly benefit from receiving oxygen on an ongoing basis. Making this determination typically involves diagnostic testing conducted at another facility or at the patient's home.

The physician's office typically fills out a request form by hand and then faxes that to a testing facility or service provider. The request is then processed manually by the facility or provider. The provider needs to take various steps to log the request and to attempt to schedule what is needed. In the home-test situation it is necessary to coordinate with a therapist to take the appropriate test equipment to the patient's home to perform the test. Additional scheduling and communication steps typically are involved at this point in the process.

Depending on whether the testing or assessment will take place in a patient's home or a testing facility, various steps must be completed. At a testing facility, for example, arrangements must be made to accommodate the patient and complete the necessary data accumulation using appropriate testing equipment. Once the information is extracted from the testing equipment, it then has to be prepared for analysis. In the in-home testing situation, a therapist must take the testing device to the patient's home where the test will be performed. In many situations, the test will have a relatively lengthy duration such that it does not make sense for the therapist to remain at the patient's home. In such situations, the therapist must return to the patient's home after the test is completed to finish the process and then eventually bring the testing device or equipment to the appropriate provider facility so that the data from the test equipment can be obtained by the provider.

The results of the test obtained from the device are then put into a useable format and typically faxed to the physician's office. After receiving the fax, the physician is able to evaluate the test results and then issue an order or prescription when appropriate. This information must then be conveyed to a home medical equipment provider, by facsimile for example. At this point, the home medical equipment provider is able to arrange for providing the appropriate equipment to the patient for use by the patient on an on-going basis.

Prior to providing the equipment to the patient, however, medical reimbursement payor organizations such as Medicare or other private insurance companies, typically require a third party confirmation of the in-home assessment results. Of course, this involves additional scheduling and visits to the patient's home and obtaining the test equipment data. This process introduces additional delay between the physician's initial desire to provide the patient with the home therapy and the ultimate delivery of the therapeutic device or services. This third party assessment also involves additional cost to the payor organization.

Once the appropriate approvals are obtained, the home medical equipment provider arranges for the patient to receive the necessary equipment to fulfill the physician's order or prescription. This does not end the process, however, because the home medical equipment provider needs to obtain payment from the payor organization.

A certificate of medical necessity (CMN) is required from the prescribing physician before the home medical equipment provider can be paid. A CMN may be, for example, Form 484.2, which is a required Medicare document for reimbursement. The required document or CMN details the specific need, medical order and equipment or services to be provided. Current regulations require that a physician complete a CMN by hand and sign the form.

This additional step in the process introduces further delay and difficulty for the home medical equipment provider to obtain payment. Completing certificates of medical necessity requires a physician to take additional time to personally complete the form and manually sign the form. Because the physician does not receive any compensation for completing these forms and the patient has already received the desired treatment or therapeutic equipment, there is little motivation for a physician to complete such forms as they tend to interfere with the physician's ability to conduct the daily practice of medicine. Additionally, this portion of the process introduces further cost for the home medical equipment provider, who typically, periodically needs to send an individual to the various physician offices to obtain signed certificates of medical necessity.

As can be appreciated, the entire process involves a number of individuals, duplicate efforts, burdensome paper work and unnecessary delays. There is a need for a strategy and system that facilitates the process of providing home medical equipment or similar services to a patient that avoids the unnecessary expenses and delays associated with the conventional approach. This invention addresses that need and provides further advantages.

### SUMMARY OF THE INVENTION

In general terms, this invention is an automated system that facilitates providing home medical equipment to a patient.

A system designed according to this invention allows remotely located individuals, such as medical service and equipment providers and physicians all to obtain access to commonly needed information and to coordinate various tasks in an efficient manner. A communication module allows a first individual, such as a medical professional at a physician's office, to enter patient information regarding at least one patient and to enter a request for services such as testing, analysis or equipment provision for the patient. The communication module also allows a second, remotely located individual such as a medical service or equipment provider, to determine that the request has been made. The provider is able to enter information indicating the results of having performed the requested services. The first individual is then able to access the result information from the communication module and to enter an order for appropriate medical services. The second individual (i.e., the medical service or equipment provider) is then able to retrieve the order and process the order to provide the ordered services to the patient.

In one example system, the communication network facilitates automatically generating a certificate of medical necessity at the time that the responsible physician enters the order for medical services. In a preferred embodiment, the certificate of medical necessity includes a digital signature or certificate that is accepted as if the physician had manually signed a printed out version of the certificate of medical necessity. In such an example, the system prompts the physician to answer a plurality of questions that are processed by the communication module so that the certificate of medical necessity is automatically generated and then submitted by the physician on-line.

One example system designed according to this invention is computer network-based. A plurality of individuals including home medical equipment device manufacturers can have access to selected portions of the data maintained by the system for various purposes. A system designed according to this invention preferably includes security measures that protect the data, especially that regarding patients and medical record information.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates a system designed according to this invention.

FIG. 2 schematically illustrates a communication facilitator designed according to this invention.

FIG. 3 is one example display screen presentation useful for a portion of an example process handled by a physician's office using a system designed according to this invention.

FIG. 4 is another display screen presentation useful for a portion of an example process handled by a physician's office using a system designed according to this invention.

FIG. 5 is another display screen presentation useful for a portion of an example process handled by a physician's office using a system designed according to this invention.

FIG. 6 is another display screen presentation useful for a portion of an example process handled by a physician's office using a system designed according to this invention.

FIG. 7 is another display screen presentation useful for a portion of an example process handled by a physician's office using a system designed according to this invention.

FIG. 8 is another display screen presentation useful for a portion of an example process handled by a physician's office using a system designed according to this invention.

FIG. 9 is another display screen presentation useful for a portion of an example process handled by a physician's office using a system designed according to this invention.

FIG. 10 is another display screen presentation useful for a portion of an example process handled by a physician's office using a system designed according to this invention.

FIG. 11 is a display screen presentation useful for a portion of an example process handled by a physician's or provider's office using a system designed according to this invention.

FIG. 12 is another display screen presentation useful for a portion of an example process handled by a physician's or provider's office using a system designed according to this invention.

FIG. 13 is another display screen presentation useful for a portion of an example process handled by a provider's office using a system designed according to this invention.

FIG. 14 is another display screen presentation useful for a portion of an example process handled by a physician's or provider's office using a system designed according to this invention.

FIG. 15 is another display screen presentation useful for a portion of an example process handled by a physician's office using a system designed according to this invention.

### DETAILED DESCRIPTION OF THE PREFERRED EMBODIMENTS

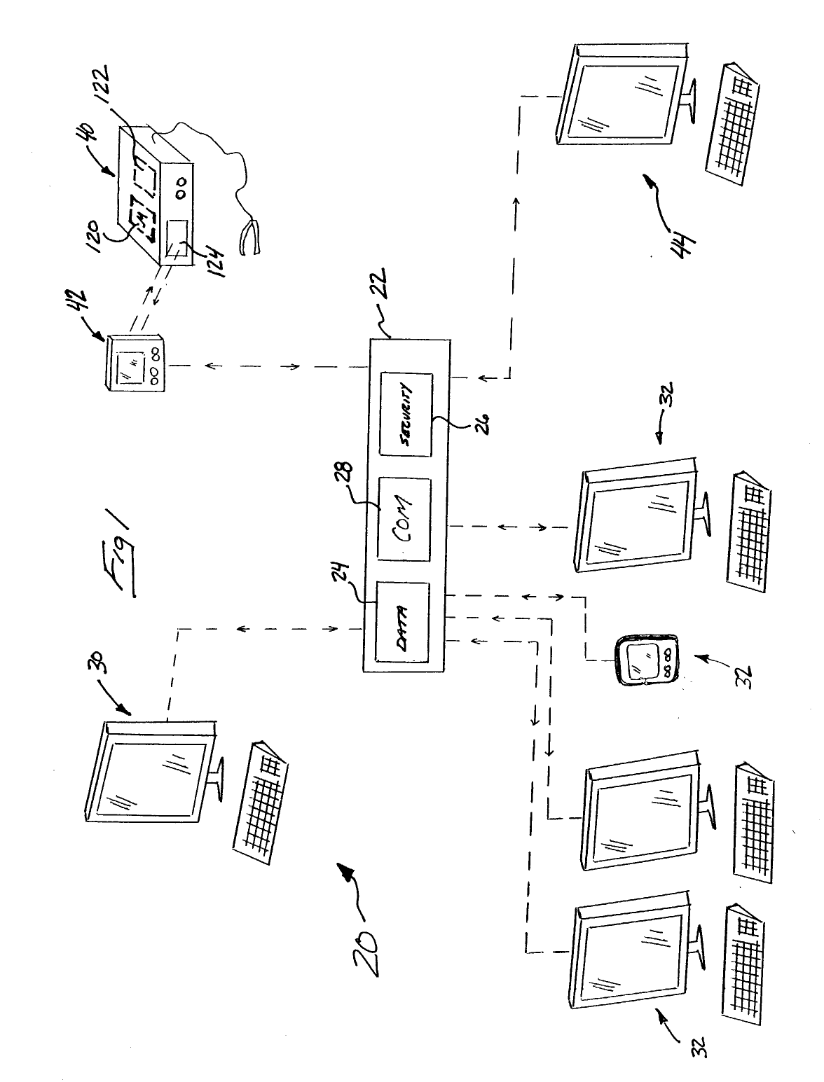

FIG. 1 schematically illustrates a system 20 for facilitating communications between the various individuals and entities involved in the process of providing medical services or equipment to one or more patients. For discussion purposes, a home medical equipment provider will be the example provider. Other providers such as laboratories, diagnostic facilities, clinics, therapists, nursing organizations and hospitals will benefit from this invention. Although the described example focuses on the provision of home medical equipment, this invention is not so limited. Given this description, those skilled in the art will realize the wide-ranging usefulness of the inventive system.

A communication facilitator 22 includes a data management module 24, a security module 26 and a communication module 28. In one example, the communication facilitator 22 is a computer-based network. Such a network may be implemented through internet, intranet, Ethernet technologies, private networks, wireless communication or infrared communication technologies, for example. Those skilled in the art who have the benefit of this description will be able to determine which of these available technologies (or what combinations of such technologies) will best suit the needs of their particular situation.

The data module 24 includes computer software and storage that facilitates handling and maintaining the various kinds of data required during the process of providing various medical services, home medical equipment or both. The data module 24 also facilitates managing data such as physician patient records, testing or assessment requests, testing results, physician orders, etc. The security module 26 provides security measures to prevent unauthorized access to or use of data or the communication facilitator 22. The security module 26 preferably also provides other features for authenticating various items utilized in the process as will become apparent below.

It should be noted that the use of the term “module” in this description is not to be construed in a limiting sense. The various modules or divisions within the communication facilitator 22, for example, are schematic and only for discussion purposes. A module may be a portion of software or a grouping of various portions, for example. Moreover, various functions within one module may be performed by the same software components as used within another module. The illustrated divisions or groupings of the inventive system into modules is for discussion purposes, although those skilled in the art who have the benefit of this description may realize that such divisions have applicability in a system designed according to this invention.

The communication facilitator 22 facilitates communications between a medical service or equipment provider such as a home medical equipment (HME) provider 30 and a plurality of physician offices 32, for example. The HME provider 30 is remotely located from the physician offices, which are also remote from each other. The communication facilitator 22 may facilitate modem communications, dedicated communication lines, wireless communications such as cellular networks or satellite links and other suitable media for sharing data among remotely located entities. A variety of communication devices can be used with an appropriately designed network.

As will be appreciated from the following description, the communication facilitator 22 greatly simplifies, speeds up and enhances the economies associated with the process of providing medical services or home medical equipment to one or more patients. For discussion purposes, the example of providing a patient with oxygen at home will be used. This invention, however, is not limited to such a situation. A variety of types of home medical equipment and a variety of therapy regimes or modalities can be accommodated with a system designed according to this invention.

In addition to communications between physician offices 32 and a home medical equipment provider 30, the system 20 facilitates data retrieval from test equipment 40 such as an oxymeter. Portable, remote communication devices 42 such as cellular phones, personal digital assistants or so-called palm top computers are useful for communicating information to or receiving information from the communication facilitator 22. Such remote communication devices are viable by all individuals having access to the communication facilitator 22 in one example implementation of this invention.

In the illustrated example, a home medical equipment device manufacturer 44 also has restricted access to certain information within the system 20. This may be useful in situations, for example, where a device manufacturer desires to monitor the use of the various devices available in the market to focus future research and development efforts.

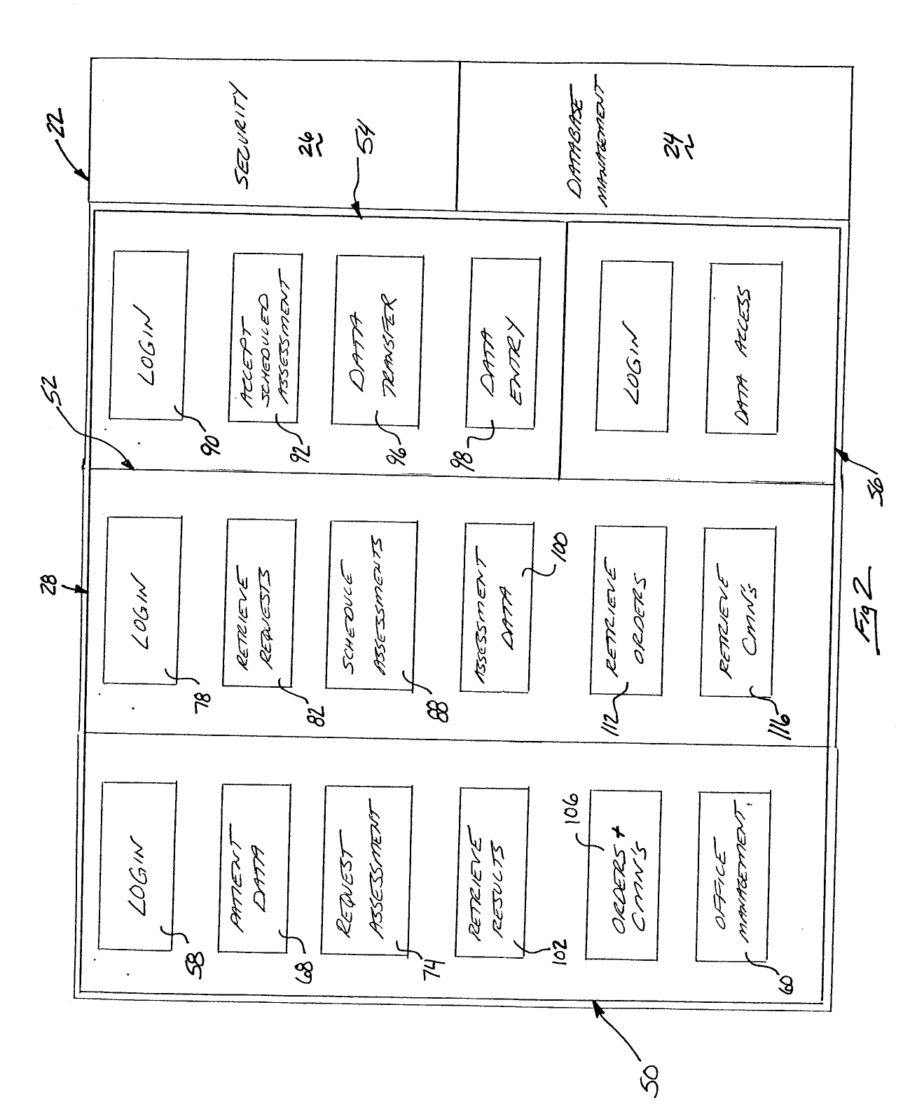

Referring to FIG. 2, the communication facilitator 22 includes the communication module 28 which is schematically subdivided for purposes of illustration. In one example, the communication facilitator comprises computer software, which may be stored on known storage media. A first portion 50 is dedicated, in the illustrated example, to physician access to and use of the system 20. A second portion 52 is dedicated to the use of the system 20 by the home medical equipment provider 30. A third portion 54 of the communication module 28 is dedicated to facilitating communications with a therapist or other medical professional who visits the patient's home as needed. Another portion 56 is dedicated to communications with entities such as the HME device supplier 44 to provide the type of access described above.

The first portion 50 preferably facilitates a physician or another authorized individual from a physician's office gaining access to the network 22. A log in module 58 preferably includes suitable programming to present the first individual at the physician's office with a login screen on a computer display or other suitable device. FIG. 3 shows an example login screen 64 illustrating the type of information associated with the physician or the physician's office so that all transactions involving that individual can be tracked and linked to associated data or information within the system 20.

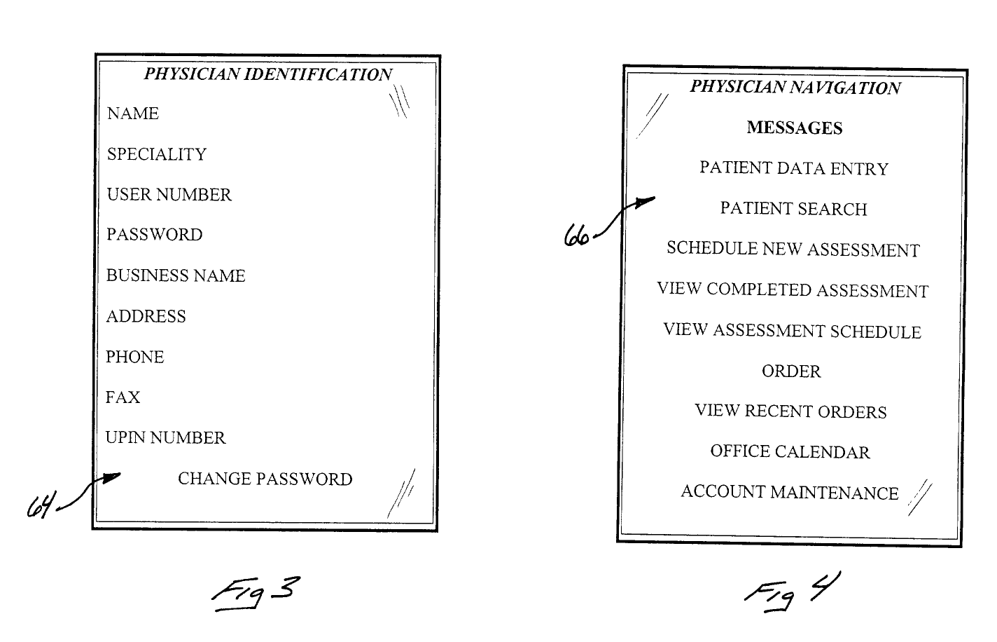

Upon appropriately logging into the system, the physician preferably is presented with a main menu or navigation screen such as the example screen 66 shown in FIG. 4. As can be appreciated from the illustration, the physician preferably is presented with a plurality of options to select for performing different functions using the system 20. In the illustrated example, the screen display 66 includes a messages portion that the physician may access to retrieve messages regarding, for example, assessment results obtained and available on the system. By selecting the choice “View Completed Assessment,” for example, the physician can obtain details regarding one or more assessments that have been performed and for which data has been appropriately entered into the network 22. The various options for the physician will be described in the following paragraphs as an example transaction using the inventive system will be described.

The beginning of a typical situation involving providing home medical equipment to a patient usually involves the patient visiting the doctor's office. To utilize the inventive system, the physician, or another authorized individual at the physician's office, enters patient data into the network 22. A patient data module 68 facilitates gathering the information entered and associating that information with other data within the network as appropriate. In one example, each patient has a specific identification number that is associated with all records pertaining to that patient within the network, which provides convenient access and retrieval of all such information at a later time.

One example screen display that prompts appropriate patient data entry is shown in FIG. 5. The screen display 70 shows the type of information that is used in one example embodiment of this invention. The type of information that may be contained in a patient's chart maintained at the physician's office can be entered into the network 22 so that such information can be used in the course of providing home medical equipment or used for other general practices by the physician. In other words, the inventive system has the additional benefit of facilitating a physician maintaining patient records in an easily accessible and useful format.

In the illustrated screen display 70, after the patient data information is appropriately entered, several selections such as scheduling an assessment, scheduling an office visit or scheduling some other event are presented which can be accessed using a mouse device or conventional keyboard, for example. The first portion 50 of the communication module 28 preferably is programmed to present a subsequent screen display to the user corresponding to the selection made.

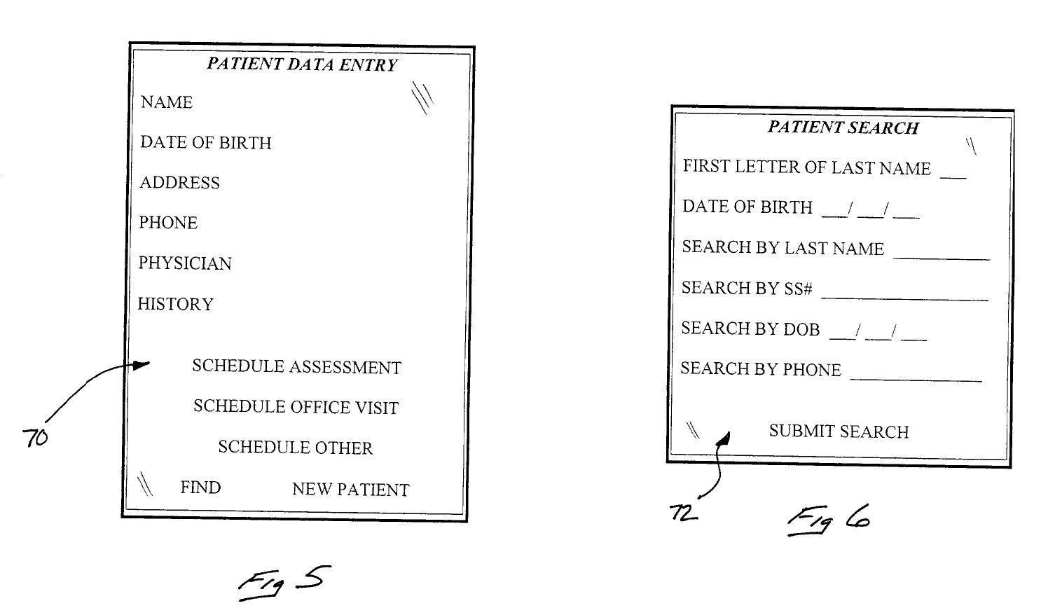

In situations where a patient's information has already been entered into the system, the authorized individual at the physician's office may choose the find option on the screen display 70 to search for that patient's records. An example screen display 72 is shown in FIG. 6 facilitating a patient search. The illustrated example embodiment of this invention preferably allows several search options such as searching by the date of birth and the first letter of the last name of the patient, searching by the patient's complete last name, searching by the patient's social security number or other identifying information such as a date of birth or phone number. Compound searching capability is included in one example implementation of this invention. The presentation of the retrieved patient records may be customized depending on the needs of a particular physician's office or specialty, for example. Those skilled in the art who have the benefit of this description will realize the various ways of presenting the patient data information to an authorized individual at a physician's office.

When a physician determines that therapy involving home medical equipment may be useful for a patient, the physician often needs to request an in-home assessment to verify that the proposed therapy will be beneficial or that the patient's condition is such that an insurance company or Medicare will pay for the proposed therapy and home medical equipment. The communication module 28 facilitates such requests with a request assessment module 74. If a physician selects the option for scheduling an assessment on the display screen 70 or 66, the communication module 28 preferably causes the request assessment module 74 to be activated and to facilitate the request.

An example screen display 76 is shown in FIG. 7 that prompts the authorized individual at the physician's office to enter the appropriate information to request that the assessment be made. The illustrated example includes an option for selecting an assessment code, which includes a plurality of predefined codes that are presented for an onscreen selection. An example code would refer to an oxymeter test for a patient that may benefit from in-home oxygen therapy. Once the required amount of information is entered into the system, the network 22 includes an indication of the requested assessment.

The HME provider 30 is then able to access the information regarding the requested assessment. The HME provider 30 preferably logs into the network 22 through a login module 78 that utilizes known techniques for logging in with associated identifier information and access codes allowing the HME provider 30 to access required information for handling the assessment. For example, the security module 26 preferably ensures that the data regarding the patient's medical records within the data base management module 24 cannot be altered by the HME provider 30. The example security module ensures that the physician has the ability to “read and write” patient records or data as needed. A variety of techniques for insuring the integrity of information within the data base module 24 or the network 22 generally can be used with a system designed according to this invention. Those skilled in the art who have the benefit of this description will be able to select the appropriate technique to best suit the needs of their particular situation.

FIG. 11 illustrates an example main menu display screen 80 that allows the HME provider 30 to navigate through the network 22 to accomplish a desired objective. A retrieve request module 82 preferably is activated if the user at the HME provider 30 selects the “View Requested Assessments” choice on the display screen 80, for example. This allows the HME provider to determine what physicians have requested specific assessments for individual cases and then to determine whether that provider desires to have that assessment performed with a view towards eventually providing the home medical equipment to that patient if necessary.

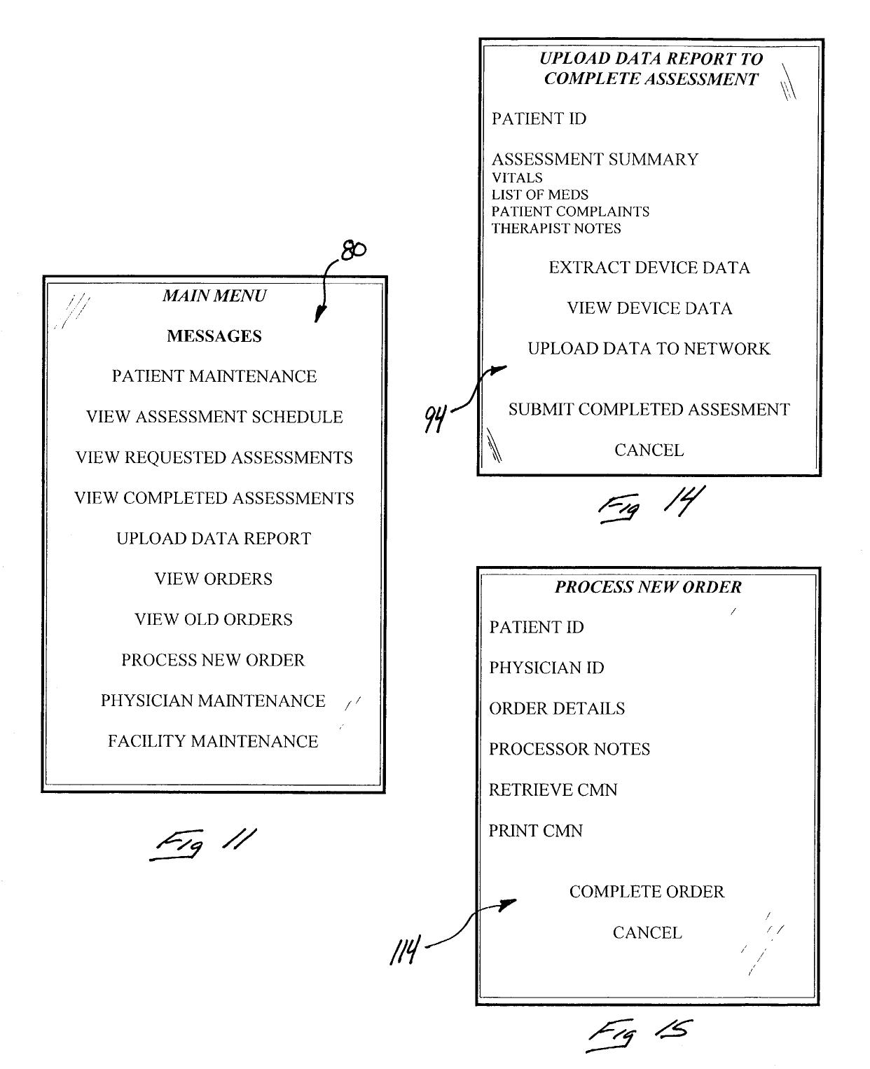

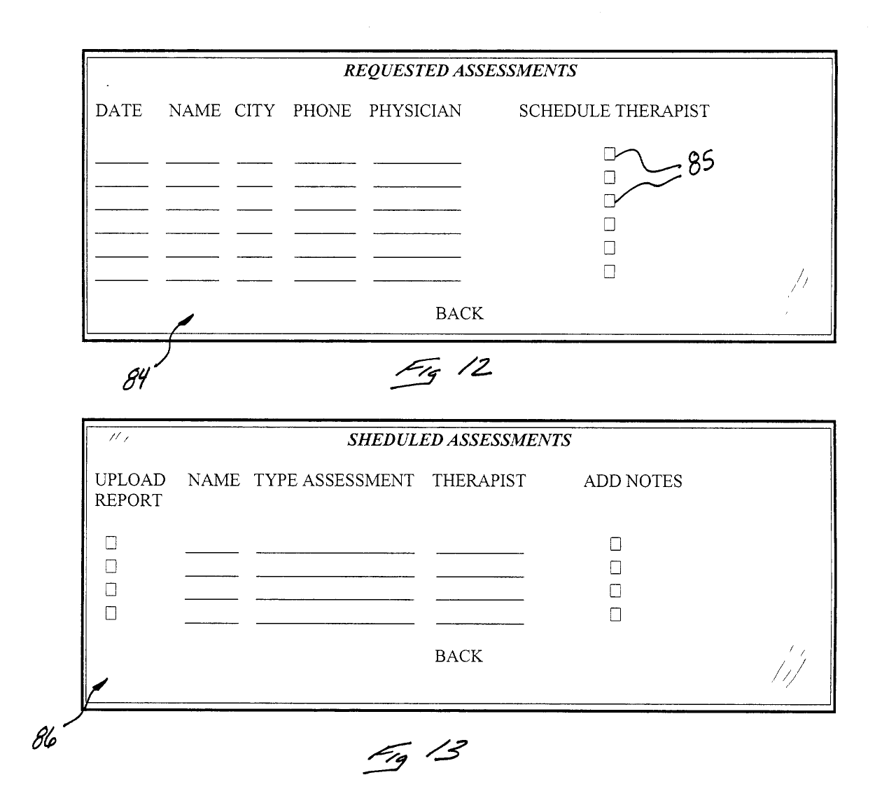

FIG. 12 illustrates one example arrangement of a screen display 84 that a home medical equipment provider can use to decipher which requests it desires to accept. The illustrated example includes selection buttons 85 that can be accessed using a mouse device, touch screen or a keyboard interface, for example. The HME provider 30 selects which assessments to perform and schedules a therapist or other medical professional to go to the patient's home to perform the necessary test to complete the assessment.

An example scheduling screen 86 is shown in FIG. 13. By entering information as appropriate into the system using screen 86 as a guide, a schedule assessments module 88 facilitates getting the appropriate data entered into the appropriate portions of the network 22 so that the assessment eventually gets performed by the desired therapist or other professional. The screen 86 may be presented on the display at the HME provider's facility. The same screen or a similar screen may be presented to the therapist who access the network 22 to accept the scheduled assessments. Such therapists may be employees of the HME provider or may be contractors that work with the HME provider, depending on a particular situation. The display screen 86 may be available, for example, on the portable communication device 42, which is carried around by the therapist on a routine basis.

The therapist or other professional preferably logs into the network 22 through a login module 90 with a portable communication device such as a cellular phone, laptop computer or personal digital assistant. An accept scheduled assessment module 92 preferably facilitates the therapist indicating the desire to accept and perform a particular assessment. By entering information into the network 22, the therapist is able to communicate to the HME provider 30 that the scheduled assessment will be performed. The therapist preferably has the ability to update information in the network 22 so that the progress on various scheduled assessments is available at any time for the HME provider 30 to review. In one example, authorized individuals at the physicians' offices are also able to track the progress of scheduled assessments.

One time-consuming shortcoming of the process used before this invention was that the therapist typically had to obtain equipment from the HME provider, take that equipment to the patient's home, perform the necessary testing, return to the patient's home to retrieve the testing equipment, take that equipment back to the HME provider and then travel to another patient's home for another assessment. The additional travel time back and forth between the HME provider facility and the various patients' homes introduces time delays and additional expense that can be avoided when using one example implementation of the inventive system.

According to one embodiment of this invention, the therapist is able to take the testing device 40 to the patient's home, obtain information from the testing device after the test has been completed and to remotely communicate that information to the network 22 so that such information then becomes available to the HME provider 30 without requiring the therapist to return to the HME provider facility. Accordingly, the therapist is able to take the testing device 40 from one patient's home directly to another patient's home, which presents significant time and cost savings.

A data of transfer module 96 preferably facilitates obtaining information from the testing device 40 and placing that information into appropriate portions of the network 22. Such data transfer preferably is accomplished using known wireless communication technology.

A data entry module 98 facilitates the therapist entering other information into the network needed in connection with a completed assessment report. The display screen 94 preferably prompts the therapist to enter in information such as the patient name, assessment summary information and to ensure that the data from the test device 40 is placed onto the network 22. The display screen 94 preferably is presented on the portable communication device 42.

Once the assessment information has been completely entered into the network 22, the HME provider 30 preferably utilizes an assessment data module 100 to ensure that the information is complete and available for review by the requesting physician.

A retrieve results module 102 allows the authorized individual at the physician's office to obtain the completed assessment report online. This allows a physician, for example, to access such information even though the physician is away from her office. Such added convenience not only is beneficial for a physician to manage their practice, but also facilitates more quickly getting the necessary equipment to the patient to provide the desired therapy.

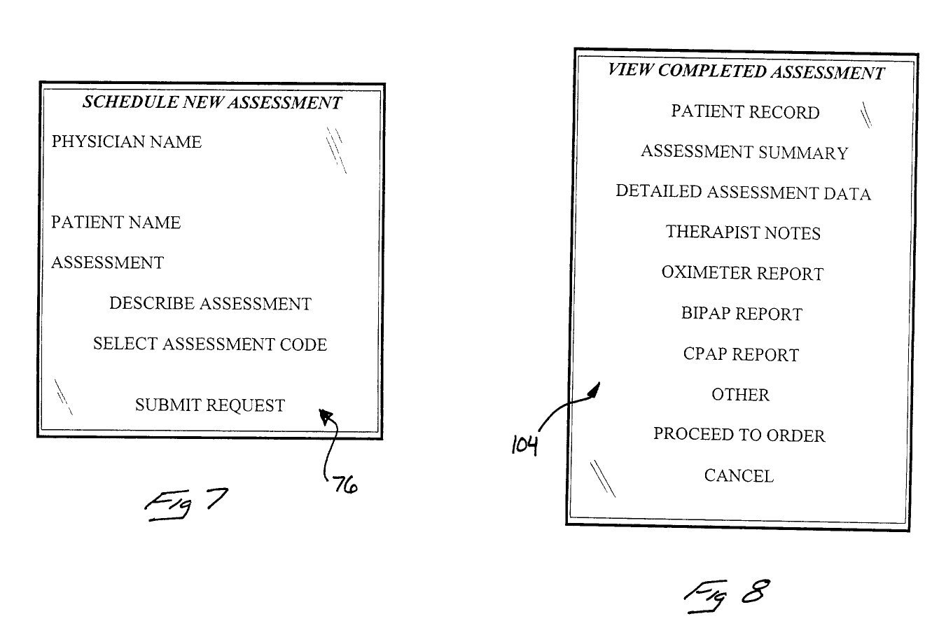

An example screen display 104 is shown in FIG. 8 giving the physician a variety of options to select information to be displayed regarding the assessment. A “Proceed To Order” option on the screen 104 allows the physician to move forward in the process to order the desired home medical equipment and therapy based upon the physician's evaluation of the assessment results. An ordering and certificate of medical necessity generating module 106 facilitates the physician placing an order through the network 22 and completing a certificate of medical necessity (CMN) at the same time as placing the order. A significant advantage associated with this invention is the automatic generation and submission of CMNs.

An example screen display 108 is shown in FIG. 9 to facilitate a physician placing an order or prescribing a desired therapy and provision of home medical equipment to a patient. In the illustrated example, one of the options available is selecting an order code. In this example, the network 22 preferably includes storage of a plurality of preset codes that are consistent with expected requested therapies so that order placement is easier on a repeated basis.

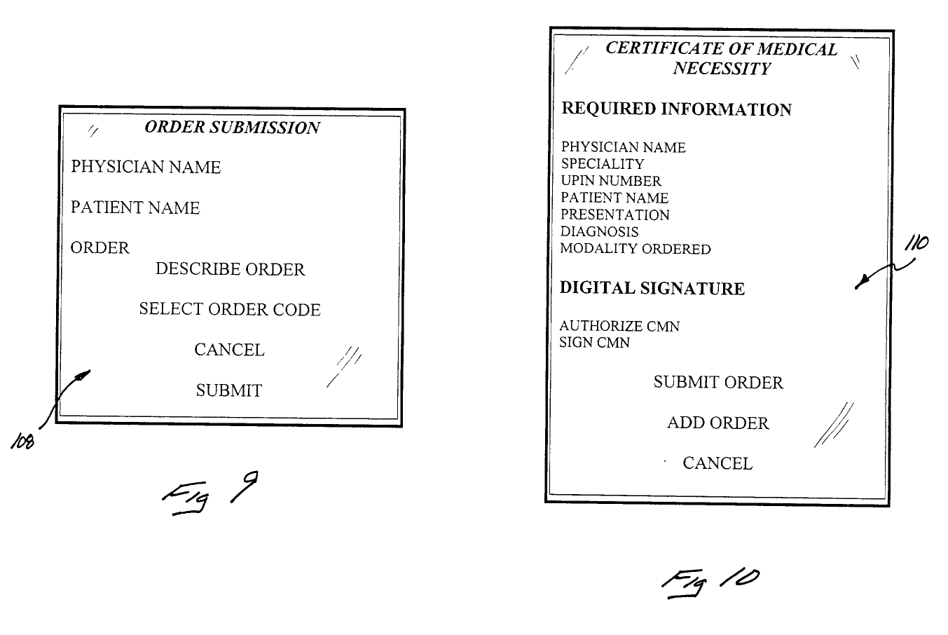

The inventive arrangement preferably causes a CMN to be automatically generated as part of the order submission process. In the illustrated example, when the “Submit” selection on the screen 108 is chosen, the system presents the physician with a display screen 110 as shown in FIG. 10, for example. This display screen (or a series of screens, depending on a particular situation) prompts the physician to answer a series of questions to provide the necessary information for completing a CMN. Without the necessary information, the system 20 will not allow the physician to submit the order, which ensures that the HME provider 30 obtains a CMN on a timely basis, which is essential to the HME provider for obtaining reimbursement for the home medical equipment provided to the patient.

A physician conveniently can utilize a computer located at their office or a remote communication device such as a personal digital assistant to complete the order process and filling out the automatically generated CMN. This portion of the example process utilizing the inventive system demonstrates one use of wireless technology for producing various information without redundancy to each participant in the process.

Advantageously, the illustrated example includes incorporating a digital signature or digital certificate of authentication onto the CMN within the network 22. The digital signature fulfills the same purpose as a manual signature by a physician on a hardcopy of the CMN. With the inventive arrangement, a hardcopy of the CMN need not be kept by the physician unless the physician desires to place one within the office copy of the patient's records, for example. A variety of known digital signature technologies may be used to facilitate secured authorization only by authorized physicians so that the integrity of an automatically generally CMN provided by the system 20 is ensured. Example cryptographic algorithms such as RSA, Diffie-Hellman technology, ElGamal and digital signature imaging. Those skilled in the art who have the benefit of this description will be able to select from among available security techniques or to custom design their own to meet the needs of their particular situation.

Once the automatically generated CMN is appropriately completed, authorized and digitally signed by the physician, the order is placed on the network 22. The HME provider 30 then is able to retrieve the order and decided whether to fulfill it. A retrieve order module 112 facilitates the HME provider 30 doing so. A display screen 114 shown in FIG. 15 facilitates completing the order at the HME provider facility 30. As part of completing the order, the processor at the HME provider 30 preferably is required to retrieve the associated CMN from the network 22 and, in some instances is required to print out a hard copy of the CMN. The CMN is critical to obtaining reimbursement from Medicare or an insurance provider, for example. By obtaining the CMN at the same time as accepting the order, the HME provider 30 has a significant economic advantage compared to the conventional approach of trying to obtain signatures from physicians that are located all around a given geographic area and are busy attending to other aspects of their medical practice, which typically makes manually completing and signing the conventional certificate of medical necessity an undesirable task. A retrieve CMN module 116 preferably facilitates the HME provider obtaining the CMN and cooperates with the security module 26 to ensure the integrity of the CMN so that they will be acceptable by Medicare or the private insurance provider.

As can be appreciated, the inventive system 20 greatly simplifies, speeds up and economizes the entire process of providing individuals with home medical equipment. The inventive system 20 handles the process from beginning to end in an automated fashion that provides up-to-date information to a variety of individuals with convenient, remote access as needed. Moreover, by automatically generating certificates of medical necessity in an acceptably authorized fashion, the inventive arrangement puts a home medical equipment provider at a significant advantage for obtaining payment for the services rendered and the equipment provided.

The illustrated example implementation of this invention includes another benefit. This embodiment includes a technique for securely extracting data from the testing device 40. The portable communication device 42 is capable of communicating with a microprocessor or controller 120 within the testing device 40, which may be an oxymeter, for example. In one example, a hardwire connection is used between the device 40 and the device 42. In another example, wireless communication between those two devices facilitates the necessary data extraction from the device 40 and data provision from the device 42.

The illustrated oxymeter device 40 includes a data portion 122 and a communication portion 124, both of which are controlled by a suitably programmed controller 120. Given this description, those skilled in the art will be able to select appropriate electronic components and to appropriately program them to achieve the results provided by this invention. In one example, the communication device 42 wirelessly communicates through the communication portion 124 using a known web clipping technique. Other known techniques are used in other examples. This allows two-way wireless communication between the devices 40 and 42.

A therapist can enter patient identification information and assessment notes, for example, that are then appropriately processed by the controller 120 to be associated with the testing data generated by operation of the device 40.

To insure accurate data is extracted from the device 40, the memory 122 preferably only provides information to the device 42 in a read only format. In one example, the controller 120 is programmed to delete the information from the memory 122 once it is uploaded to the communication device 42 so that the extracted information cannot be later retrieved or modified.

Ensuring the integrity of the information from the device 40 facilitates further streamlining the process of providing home medical equipment to a patient. This example includes protecting the information generated by the device 40 by using a conventional compression technique that puts the data into a “locked” format accessible only by authorized persons on the network 20.

In the conventional approach, a third party verification assessment is required by Medicare and most private insurance carriers. Such third party assessments are required to prevent fraud or manipulation of data from an assessment to obtain approval for home medical equipment that might not otherwise be needed. With the inventive arrangement, the security of the information from the testing device 40 can be protected so that the payor organization need not require a third party assessment verification. The security module 26 of the network 22 further preferably includes programming that ensures that data received from a testing device 40 is unalterable within the network 22.

The inventive arrangement has wide-ranging applicability for facilitating communications between various entities involved in providing medical services, equipment or both. The inventive arrangement greatly simplifies and streamlines the processes required to maximize efficiency in providing medical services or equipment to patients. The ready access to and sharing of information for various remotely located individuals using a communication module represents a significant advancement providing advantages such as reducing costs and expenses, increasing the accuracy of available information, increasing the availability of services for patients, reducing the extraneous, time-consuming workload on physicians and provides the ability for medical device manufacturers to better match the needs according to current patient care trends. The inventive arrangement has applicability beyond the provisions of home medical equipment, which was the focus of the above discussion for purposes of describing one example implementation and use of this invention.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A system for facilitating communication between remotely located individuals engaged in providing medically related services comprising:
a communication module that allows a first individual to enter patient information regarding at least one patient and to enter a request for services for at least the one patient and that allows a second, remotely located individual to determine that the request has been made and to subsequently enter information indicative of results of performing the requested services such that the first individual is able to access the result information and then to selectively enter an order for medical services that is accessible by another individual that processes the order to provide the ordered services.

2. The system of claim 1, wherein the communication module facilitates automatically generating a certificate of medical necessity when the first individual enters the order for medical services.

3. The system of claim 2, wherein the communication module includes a certificate of medical necessity generation module that prompts the first individual to answer a plurality of questions and uses the answers to the questions to generate the certificate of medical necessity.

4. The system of claim 3, wherein the generation module prompts the first individual to authorize the certificate of medical necessity by prompting the first individual to enter a digital signature indicating the first individual's signatory authority and wherein the communication module allows the second individual to retrieve the certificate of medical necessity.

5. The system of claim 3, wherein the generation module attaches a digital signature to the certificate of medical necessity responsive to an authorization command from the first individual.

6. The system of claim 1, wherein the communication module allows the second individual to schedule the requested services and allows a third individual to access the scheduled services and to provide information to the network regarding a status of the services and completion of the services.

7. The system of claim 1, including wireless communication between at least one portable communication device and the communication module.

8. The system of claim 1, wherein the communication module comprises a plurality of instructions executable by a computer that are contained on a computer-readable medium.

9. The system of claim 1, including a database module that includes storage for maintaining data processed through the communication module and a security module that maintains only selected access to and use of the communication module and data stored by the database module.

10. The system of claim 1, including at least one testing device used to perform the requested services and wherein the communication module receives information extracted from the testing device and makes that information available to the first and second individuals.

11. The system of claim 10, wherein the testing device includes a data storage portion that is operative to store information gathered by the testing device and wherein the data storage portion prevents any alteration of the data within the data storage portion based upon input other than directly from the testing device.

12. The system of claim 11, wherein the testing device includes a controller portion that is operative to erase any data from the data storage portion once the controller determines that the data has been transferred to another device in communication with the testing device.

13. A computer readable storage medium containing a plurality of computer executable instructions for automatically providing a certificate of medical necessity, comprising:
a first set of instructions directing the computer to require answers to a plurality of preselected questions;
a second set of instructions directing the computer to incorporate the answers into a certificate of medical necessity; and
a third set of instructions directing the computer to require an electronic authentication of the certificate of medical necessity containing the incorporated answers.

14. The storage medium of claim 13, including instructions directing the computer to store the certificate of medical necessity containing the electronic authentication and the incorporated answers such that the contents of the stored certificate of medical necessity cannot be changed once the authentication has been associated with the certificate of medical necessity.

15. The storage medium of claim 13, including instructions directing the computer to affix a digital signature to the certificate of medical necessity responsive to the electronic authentication.

16. A method of facilitating providing medical services or equipment to a selected patient, comprising the steps of:
providing a communication module that is operative to allow communications between remotely located individuals;
allowing a first individual to place a request for services for the patient using the communication module;
allowing a second individual remotely located from the first individual to retrieve the request using the communication module;
at least temporarily maintaining information indicating results from performing the requested services in a form that is accessible using the communication module;
allowing the first individual to access the information indicating the results using the communication module;
allowing the first individual to order medical services or equipment for the patient using the communication module; and
allowing another individual to retrieve the placed order using the communication module.

17. The method of claim 16, including automatically generating a certificate of medical necessity when the first individual places the order.

18. The method of claim 17, including not allowing the order to be placed until the first individual provides a selected amount of information to complete the certificate of medical necessity.

19. The method of claim 17, including prompting the first individual to authorize associating a digital signature with the certificate of medical necessity.

20. The method of claim 17, including maintaining the certificate of medical necessity in an unalterable form such that it can be retrieved but not altered using the communication module.
